(19) United States
(12) Patent Application Publication
(10) Pub. No.: US 2025/0155593 A1
(43) Pub. Date: May 15, 2025

(54) CABLE SENSORS MONITORING METHOD AND SYSTEM

(71) Applicant: SERCEL, Carquefou (FR)

(72) Inventors: Viktor SMIRNOV, Carquefou (FR); Thibaut CAPPE DE BAILLON, Massy (FR)

(21) Appl. No.: 18/505,240

(22) Filed: Nov. 9, 2023

(51) Int. Cl. G01V 1/18; G01V 1/38

(52) U.S. Cl. CPC G01V 1/186; G01V 1/3843

(57) ABSTRACT

A method for determining the health of an individual sensor, within a plurality of individual sensors that are wired together to form a receiver point. The method includes receiving positions of the plurality of individual sensors along the cable, recording the trace associated with measured plural signals from the plurality of individual sensors, as an external device moves along the cable, past the individual sensor, and determining a health status of the individual sensor of the plurality of individual sensors by identifying a signature S_{I} of the individual sensor in the recorded trace. The external device emits a noise when moving along the cable, and the noise is detectable only by the individual sensor of the receiver point when the external device is located over the individual sensor.

### BACKGROUND

### Technical Field

Embodiments of the subject matter disclosed herein generally relate to systems and methods for monitoring the health of sensors distributed within a cable and, more particularly, to determining the state of sensors distributed in groups within streamers that are towed underwater.

### Discussion of the Background

Marine seismic surveying investigates and maps the structure and character of geological formations under a body of water using reflection seismology. Reflection seismology is a method of geophysical exploration especially helpful in the oil and gas industry. In marine reflection seismology, the depth and the horizontal location of features causing reflections of seismic waves are evaluated by measuring the time it takes for the seismic wave to travel to receivers. These features may be associated with subterranean hydrocarbon reservoirs.

A typical marine seismic surveying system is illustrated in FIG. 1. A vessel 100 tows a seismic source 102 and plural streamers 106, each streamer carrying an array of seismic sensor groups 104 (e.g., a sensor group 104 includes one or more individual sensors, e.g., hydrophones, geophones, accelerometers, etc., and plural individual sensors are wired together to form the sensor group 104; although each individual sensor measures a corresponding signal, the signals from a sensor group 104 are combined together, as the streamer level, so that a sensor group 104 outputs a single trace). It is desirable to maintain the streamers at predetermined horizontal cross-line distances (i.e., along an axis perpendicular to the towing direction T), and at predetermined depths (e.g., 10 m) relative to the water surface 108. The seismic source 102 is configured to generate a seismic wave 110 that propagates downward (down, up and vertical being defined relative to gravity) toward the seafloor 120 and penetrates formations 125 under seafloor 120 until it is eventually reflected at impedance discontinuity locations such as 122a and 122b. The reflected seismic waves 130a and 130b propagate upwardly and can be detected by the (arrays of) sensor groups 104, which are distributed on streamer 106. Based on the data collected by sensor groups 104, an image of the subsurface formation is generated by further analyses of the collected data. Note that all data collected by sensor groups 104 is transmitted to a global controller 101 of vessel 100.

To maintain the streamers at a desired position (i.e., such as to have predetermined cross-line distances and predetermined depths), conventionally, a head float and a tail buoy (not shown) are attached to the ends of the streamer. Position control devices 150 (e.g., birds) may also be attached to streamer (e.g., every 300 m) to control the position of the streamer.

The sensor groups 104 are fully encapsulated within the streamer 106. FIG. 2 schematically illustrates streamer 106 including plural particle motion sensors 210 (i.e., individual sensors) for measuring the displacement of water particles, being acceleration for accelerometers or velocity for geophones, and plural hydrophones 212 (individual sensors) for measuring a change in pressure of the ambient water. These sensors are grouped (i.e., wired together to processing electronics), within a corresponding receiver point 200 (also called receiver point group). FIG. 2 shows a single receiver point 200, which corresponds to sensor group 104 in FIG. 1. However, plural receiver points 200 are distributed along each streamer. The single receiver point 200 in FIG. 2 may have a length of about 12.5 m, includes at least one controller 220 and processing electronics 222. The signals from the sensors 210 and/or 212 of each receiver point are summed (spatial filtering) to reduce the impact of different coherent noises (e.g., bulge waves, torsional waves, transverse waves, etc.) on the seismic data. Thus, the signals from the plural particle motion sensors, including hydrophones, of a single receiver point 200 are combined as a single signal (for this reason, the sensor group 104 in FIG. 1 should be understood to correspond to the receiver point 200 in one embodiment). The controller 220 and electronics 222 are configured to digitize the data from the group of the sensors for a given single receiver point 200. By arranging the sensors 210 and/or 212 into groups, and averaging the recorded seismic data registered to cut out the coherent noise propagating at a specific velocity and incident angle, a spatial filtering of the data is achieved. The generated signal associated with receiver point 200 is then transmitted, along the streamer, to the towing vessel for further processing in controller 101 and for eventually generating the image of the surveyed subsurface. FIG. 2 also shows that the sensors and electronics are fully encapsulated within skin 202 of the streamer 106, so that the operator of the streamer does not have direct physical access to the individual sensors of the receiver point.

As the streamer includes hundreds or thousands of individual sensors 210 and/or 212, which are towed for days if not weeks in the ocean during a single seismic acquisition campaign (however, the streamer is used for many campaigns over its lifetime), and the streamer is also exposed to bending (when rolled on and off the vessel at the beginning or end of each acquisition campaign, or due to marine currents) and high mechanical tension (in particular during towing), it is likely that one or more sensors will become faulty or lose their calibration, or become insensitive to a certain range of their expected frequency spectrum sensitivity. How to determine this loss of features while the streamer is fully deployed in water or while the streamer is on the deck of the vessel is currently a challenge, especially because the global controller 101 of the vessel 100 cannot individually interrogate the individual sensors 210 and/or 212, as they are wired together within each receiver point. In other words, the global controller 101 can interrogate the local controller 220 and identify a faulty receiver point (sensor array) 200, but not each individual sensor within any given receiver point.

Thus, for cables that have the grouping of sensors discussed above, being streamers or any other type of cable, there is a need to develop a new method and system for determining the status of each sensor, and whether some or all the capabilities of each sensor are still available.

### BRIEF SUMMARY OF THE INVENTION

Determining the health of individual sensors wired as a receiver point and deployed within a cable is desired so that the collected data, for example, seismic data, is not affected by the failure of one or more individual sensors or by the frequency spectrum limitation that a sensor may experience. As plural individual sensors are wired together to form a receiver point, at the cable level, and the receiver point generates a single trace for all its sensors, it is not possible to individually sample the individual sensors to determine their health.

Thus, according to an embodiment, there is method for determining a health of an individual sensor, within a plurality of individual sensors that are wired together to form a receiver point, which produces a single trace, and the plurality of individual sensors are distributed along and within a cable. The method includes receiving positions of the plurality of individual sensors along the cable, recording the trace associated with measured plural signals from the plurality of individual sensors, as an external device moves along the cable, past the individual sensor, and determining a health status of the individual sensor of the plurality of individual sensors by identifying a signature S_{I} of the individual sensor in the recorded trace. The external device emits a noise when moving along the cable, and the noise is detectable only by the individual sensor of the receiver point when the external device is located over the individual sensor.

According to another embodiment, there is a system for determining a health of an individual sensor distributed along and within a cable, and the system in includes an interface configured to receive positions of plural sensors on the cable, the plural sensors being wired together to form a receiver point that produces a single trace and a processor connected to the interface and configured to receive the trace associated with measured plural signals from the plural sensors, as an external device moves past each sensor of the plural sensors and determine a health status of an individual sensor of the plural sensors by identifying a signature S_{I} of the individual sensor in the recorded trace. The external device emits a noise that is detectable only by the individual sensor of the receiver point when the external device is located over the individual sensor.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a conventional marine seismic surveying system;

FIG. 2 illustrates a cross-section of a streamer having plural sensors wired as a receiver point;

FIG. 3 schematically illustrates a streamer having plural sections, each section having plural receiver points, and each receiver point having plural sensors wired together;

FIG. 4 schematically illustrates traces associated with various receiver points from a given section of the streamer, and each trace includes plural signatures, associated with healthy individual sensors;

FIG. 5 schematically illustrates traces associated with various receiver points from a given section of the streamer, and some traces are missing some signatures due to faulty individual sensors;

FIG. 6 is a flow chart of a method for determining the status of individual sensors that are wired together to form a receiver point;

FIGS. 7A to 7C illustrate a frequency spectrum of measured signals associated with the plural sensors that form a receiver point;

FIG. 8 illustrates a streamer having plural sections, and each section having plural receiver points, and how the health of a single individual sensor of a receiver point can be determined for a reference receiver point;

FIG. 9 is a flow chart of a method for determining the health status of individual sensors in a receiver point, without knowing a position of a sound generating device along the streamer;

FIG. 10 is a schematic diagram of a computing device used to implement the methods discussed herein.

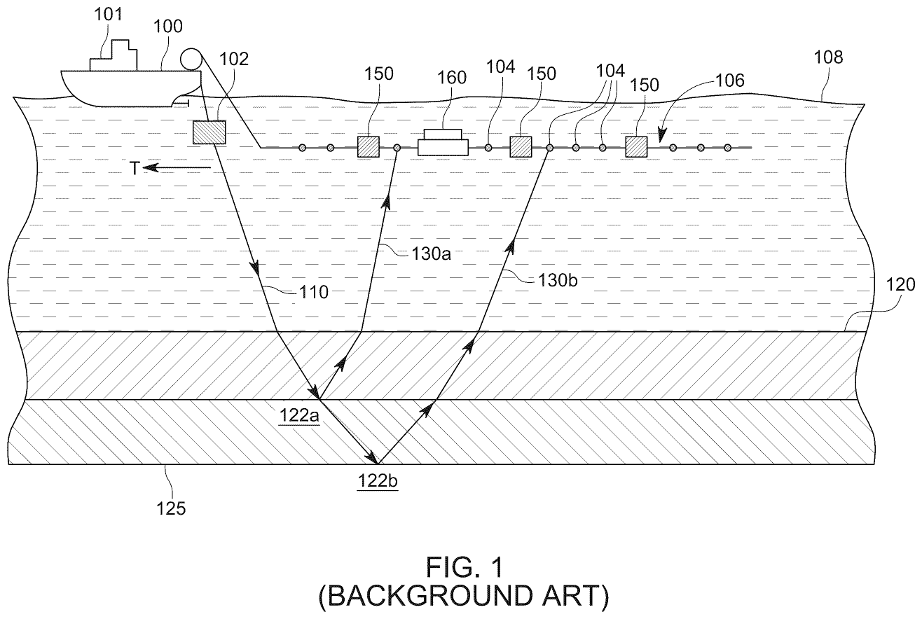

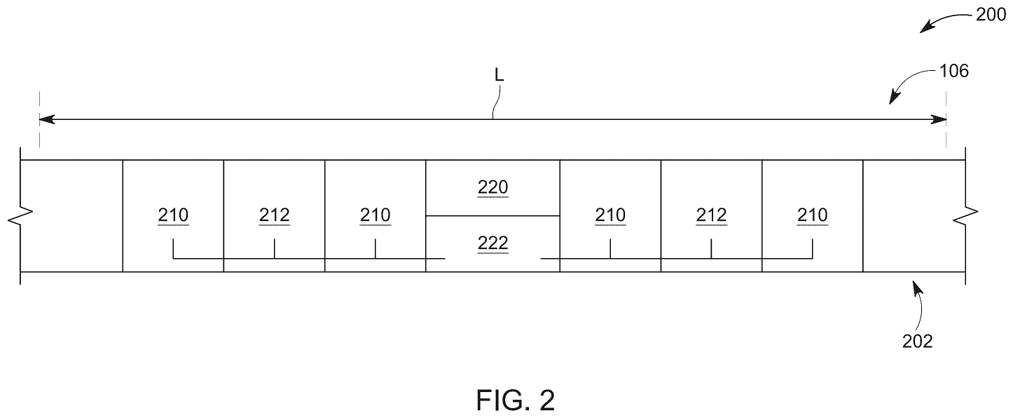

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a streamer used in marine seismic surveying. However, the embodiments to be discussed next are not limited to streamers, but may be applied to any cable that includes individual sensors wired together or to individual sensors deployed on land or on the ocean bottom and connected together, or distributed acoustic sensor (e.g., an optical fiber). Also, the methods discussed herein may be used for determining the position of a cleaning device (or any external device that is configured to move, slide, roll, glide, etc. along the cable) along the cable or streamer as the same principles apply to both situations.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The plural individual sensors (referred to, from herein on, simply as “sensors”) distributed along a streamer are used for determining a quantity (e.g., pressure) that is a direct consequence of the acoustic waves emitted by the source 102, or a quantity (e.g., displacement or speed) that is an indirect consequence of the generated acoustic waves, i.e., due to the interaction of the streamer with the acoustic wave. No matter the scenario, the inventors have realized that it is possible to take advantage of the fact that a selected external device moving outside of the streamer (e.g., a streamer cleaning device as provided by same assignee, but other cleaning devices or even non-cleaning device, even if not related to the cleaning of the streamer, may also be used for the same purpose), involuntarily generates a local noise, which is recorded by the sensors of the streamers due to their sensitivity. Due to the small footprint of the selected external device, each sensor of a receiver point can be individually excited while the other sensors of the group are not. This means that although the receiver point generates a single output (the average response of all the sensors in the group), and because only one sensor of the entire group can be excited by the selected external device, the output of the receiver point essentially is the same, for this specific scenario, to the output of the individual sensor that is excited by the selected external device. In this way, the status (health) of each individual sensor of the receiver point can be evaluated. This novel method and system are discussed in more detail next.

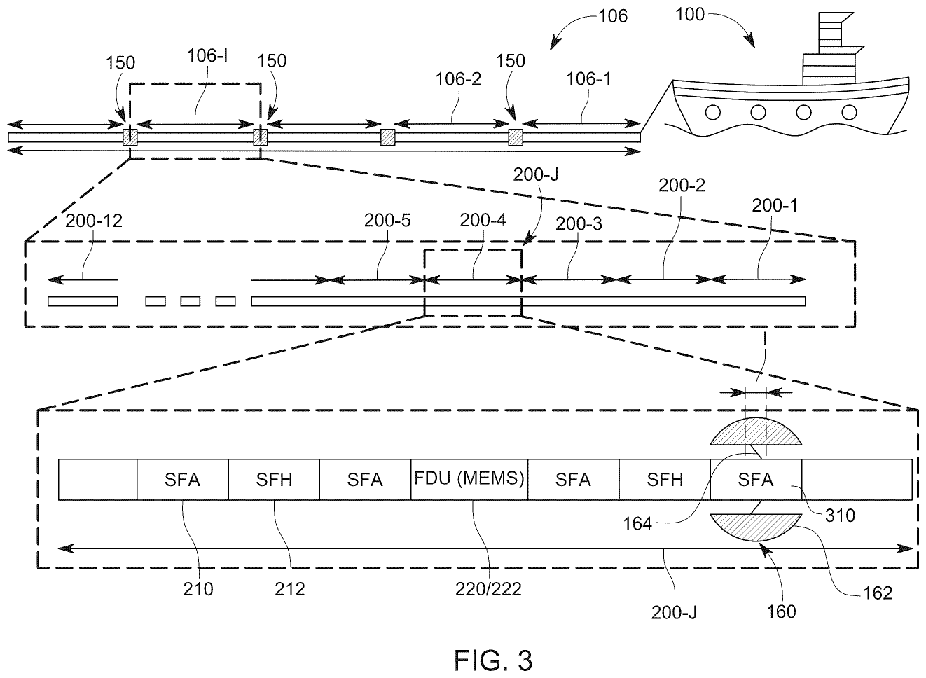

The streamer 106 having plural sections 106-1 is shown in FIG. 3, with I being an integer having a value in the tens and/or hundreds. A section 106-I may have a length of about 150 m. Other values may be used. The sections are connected to each other to form the streamer. In one application, two adjacent sections are connected to each other through a bird 150. Other connection devices may be used. Each section 106-I includes plural receiver points 200 (shown in the figure as receiver points 200-J, with J between 1 and 12), and in one application, a section includes 12 receiver points. However, the section can include more or less receiver points. A group point 200-J may have a length of about 12.5 m. Those skilled in the art would understand that other lengths may be selected. Each receiver point 200-J includes plural sensors 210 and/or 212, the controller 220, and electronics 222.

The selected external device, which is a cleaning device in the embodiments discussed herein, and thus, it is referred to, in this embodiment, as the cleaning device 160, is schematically illustrated in FIG. 3 as having a body 162 and one or more members 164 that directly contact the skin of the streamer. The member 164 is a scrapping tool in this embodiment. However, the member 164 can be different in other embodiments, for example, a wheel or a roller. While this embodiment is discussed with regard to a cleaning device that generates noise due to the pressure exerted on the skin of the streamer by the rollers of the external device, or due to the scrapping process, any external device that produces a noise, even faint, may be used instead of the cleaning device, even if no scrapping process is involved. The body 160 is configured to (fully) encircle the streamer and move along it. Internal brushes or similar devices (i.e., member 164) are configured, in this embodiment, to scrap along the streamer for cleaning the skin of the streamer. This scrapping process and/or the pressure exerted by the rollers on the streamer generates a local noise in this embodiment. However, if the external device is a non-cleaning device, then the noise may be produced by other members of the external device, e.g., the rollers or other element that directly contacts the streamer's skin, and the noise is not related to the scrapping process. For example, the external device may have a wheel that moves along the streamer. This may be enough to generate a local noise that can be recorded by the individual sensors. Those skilled in the art would understand that the cleaning device having a scrapping member that generates a local noise is just one possible implementation of the external device. Any other external device may be used with the same results as long as the external device generates a local noise that can be recorded by a single individual sensor at a given time. In this regard, as a length of the element of the cleaning device 160 that generates the noise, e.g., rollers or blade, is smaller than a length I of the part 310 that hosts a single sensor 210 or 212 associated with the receiver point 200-J, as illustrated in FIG. 3, the local noise generated by the cleaning device 160 is effectively captured only by the sensor 210 or 212 at that location, and by no other sensor of that receiver point. Note that the receiver point 200-J may include 8 hydrophones or 6 accelerometers or both of them or any number of sensors. Traditionally, when the streamer is used for recording seismic waves, the average signal (called “trace”) recorded by a single receiver point corresponds to the signals of all these sensors when all the sensors receive acoustic waves from a same seismic source. However, for this embodiment, if only one sensor of the group receives a disturbance, for example, a pressure or an acoustic wave from the cleaning device, and the other sensors of the group do not receive any other signal, like a pressure or an acoustic wave from the cleaning device or seismic signal from a seismic source (e.g., because the seismic source is not shooting), then the output of the receiver point coincides with the output of the single sensor receiving the disturbance from the cleaning device. Further, this is true even if the streamer is actively involved in a seismic data acquisition campaign as the disturbance noise generated by the external device has a different signature from the seismic waves received from the seismic source. In one application, the distance between two consecutive group points 200 is about 4 m. Other distances may be used.

According to an embodiment, after the speed of the cleaning device 160 along the streamer 106 is estimated from the collected data, it is possible to accurately identify the signature of each individual sensor on the recorded trace as the positions of the sensors along the streamer are known with precision. Knowing the signature of each individual sensor, it is possible to monitor the health of each sensor. This method may be used to perform at least one of: monitoring the evolution of the sensitivity of each sensor over time and thus allow recalibration, monitoring the impulse response of each sensor over time, detecting faulty or dead sensors, performing predictive maintenance, reducing speculations on troubleshooting, and preventing costly system recovery. While the novel measurement methods discussed herein for determining the health of the sensors are based on the local noise generated by the cleaning device, one skilled in the art would understand that any other device that travels along a cable may be used for this purpose as long as this device generates a local noise that is received by a single sensor of the group at a given instant.

In this embodiment, the cleaning device is assumed to move with a constant speed along the streamer. The cleaning device moves along the streamer due to the relative speed of the streamer in water (see, for example, the U.S. Pat. No. 9,423,527 for details about this movement). By knowing the cleaning device's speed, it is possible to determine the location of the cleaning device along the streamer at any instant. In this regard, note that one or more sections 106-1 of the streamer are sandwiched between two birds 150 and the cleaning device may not be able to pass over the birds. Thus, the cleaning device moves from one end of the one or more sections of the streamer to the other end and back. In one embodiment, the global controller 101 instructs the cleaning device 160 when to start the cleaning process, and thus, the initial time when the cleaning device starts moving along the streamer is known and may be used to check the position of the cleaning device along the streamer. However, this initial time is not necessary for determining which sensor is faulty and its location. The speed of the cleaning device 160 may be measured in one embodiment, and then the same speed is used for any situation. However, in another embodiment, the speed of the cleaning device 160 is calculated based on the measurements of the sensors 210 and/or 212.

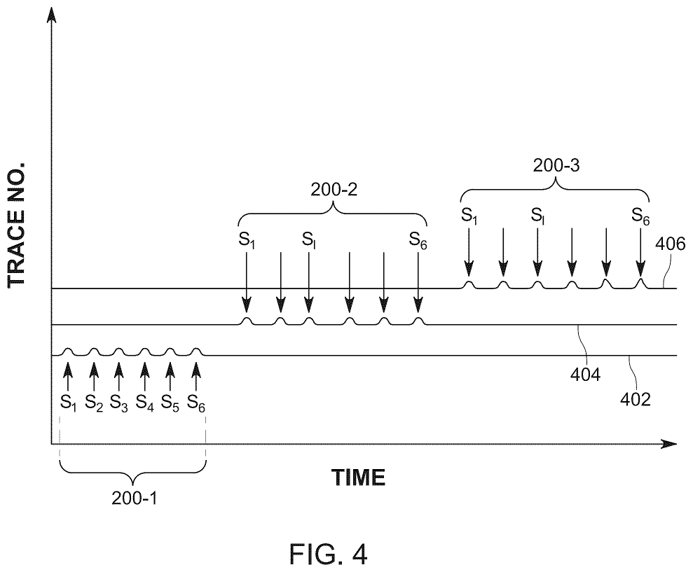

More specifically, FIG. 4 shows plural traces 402, 404, and 406 (only three traces are shown for simplicity) measured by the sensors and transmitted to the global controller 101. Note that a single trace is associated with a receiver point 200 and thus, the three traces shown in the figure are associated with three different receiver points. Also, the trace spans a given time interval, for example, couple of seconds or couple of minutes. Note that trace 402 is associated with receiver point 200-1, trace 404 is associated with receiver point 200-2, and trace 406 is associated with receiver point 200-3. Each receiver point includes, in this embodiment, six distinct sensors. FIG. 4 shows the signature of each sensor in the corresponding trace. Note that the signatures shown in the figure are not real signatures, just an indicium of how the signature of one individual sensor is recorded at a different time from the signature of another one individual sensor. Thus, although the receiver point averages the signal recorded by the six sensors and generates a single output signal, because the cleaning device 160 generates a local sound, it is possible to in fact record the signature of each individual sensor S_{I}, not smeared by the signatures of the neighboring sensors. FIG. 4 shows that all the sensors of receiver points 200-1 to 200-3 are working as each trace shows six different signatures. By knowing the exact location of the sensors and the time difference between the recorded events for these sensors, it is possible to calculate the speed of the cleaning device 160 between any two sensors. Note that FIG. 4 shows the square root of the energy measured by each receiver point. It can be seen in the figure that the cleaning device has a very local excitation because there is only ambient noise level (i.e., no signal) between two adjacent sensors.

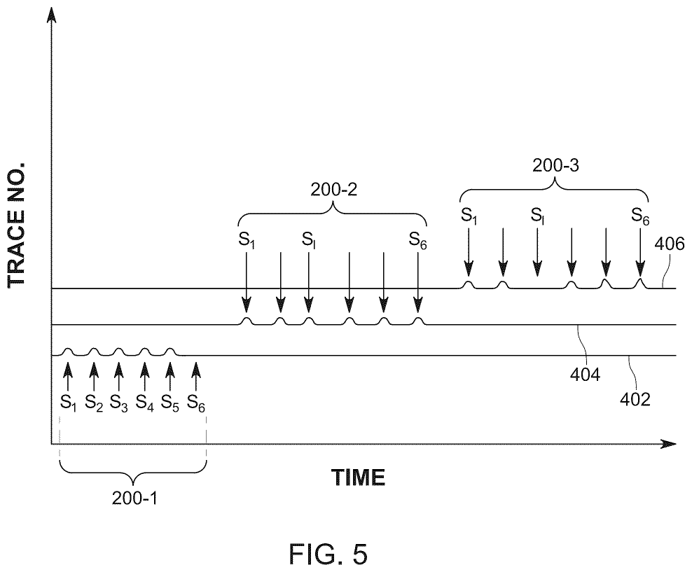

FIG. 5 has been modified to show how the traces would look when some of the sensors are not working (see, for example, sensor S₆ for group point 200-1 and sensor S_{I} for group point 200-3 are missing their signatures). Because the cleaning device's speed and the position of the sensors are known, it is then possible to know at which moment and on which trace to expect to obtain an RMS value significantly higher than the ambient noise level at the location of each sensor. If such a level is not reached for one or more sensors, one can assume that the sensor or sensors are faulty and trigger an alarm.

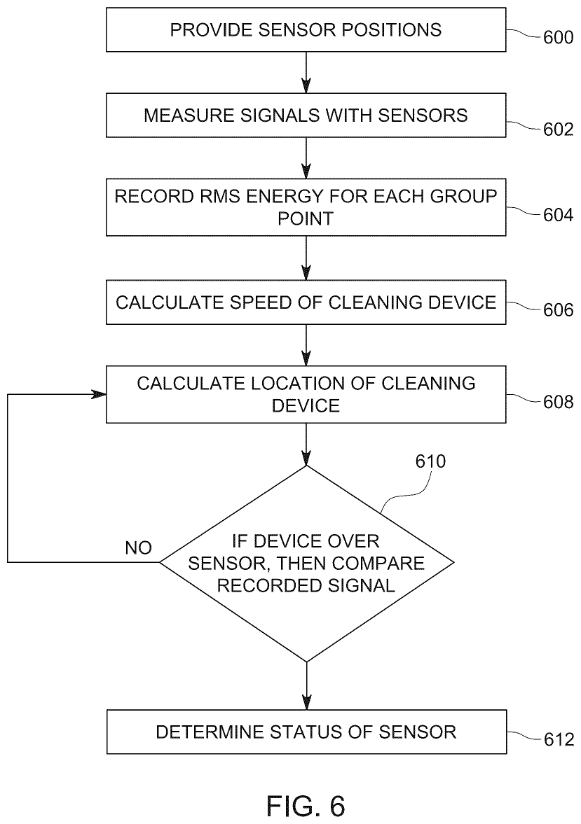

Thus, a method for determining the status of a sensor is now discussed with regard to FIG. 6. In step 600, the positions of each sensor along the streamer are provided to the global controller 101. In step 602, signals generated by the moving cleaning device are measured by sensors 210 and/or 212. Note that only the signals from some receiver points are necessary in this step, not the signals from all the receiver points. In step 606, the electronics 222 associated with the receiver point 200 averages the signals received from each sensor of the receiver point, for a given instant, and then records the RMS energy of the plural signals as a single signal. In step 606, the speed of the cleaning device may be calculated based on the signals recorded by the receiver points along the streamer. In step 608, the location of the cleaning device along the streamer is calculated based on the known positions of the sensors and the speed of cleaning device. In step 610, if the location of the cleaning device coincides with the location of a single sensor from a receiver point, then the recorded RMS energy value of the corresponding receiver point is compared to the ambient noise energy. If the measured value is not higher than the ambient noise, the sensor is potentially dead or malfunctioning. The status of the sensor is output in step 612. If the two locations are not coincident, the method returns to step 608 for updating the location of the cleaning device.

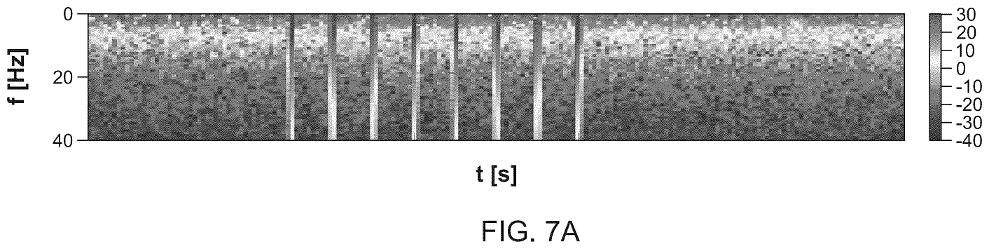

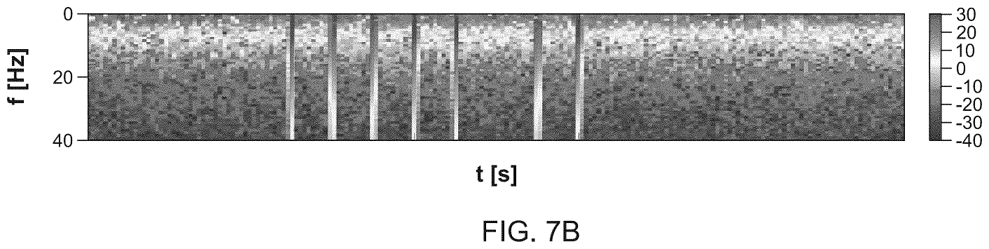

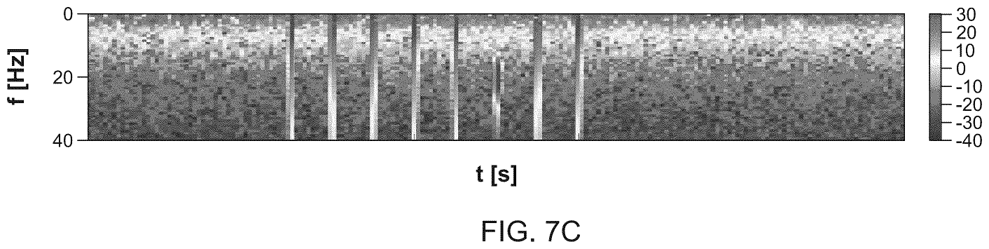

Various results may be obtained in step 614. FIGS. 7A to 7C illustrate the frequency spectrum response of a group of 8 sensors, associated with a single group point, versus time. FIG. 7A shows that the recordings of all 8 sensors are present, which indicates that these 8 sensors are working. FIG. 7B shows only 7 recorded signals for the 8 sensors, which indicates that sensor no. 6 has failed. FIG. 7C shows a scenario in which sensor no. 6 has partially failed, i.e., it produces a signal for a subset of the measured frequencies, but not for the other frequencies.

The method discussed above with regard to FIG. 6 may be used during non-acquisition periods, i.e., before an operation, during a turn of vessel 100, at the end of an operation, where the operation is considered to be the collection of seismic data. Identification of the defect sensor can take place “live,” with identification in the detected signal of a discrepancy vs. “normal” reception—or it can be delayed for later analysis of the gathered and stored signals.

The method can also work during an acquisition campaign, i.e., when seismic source 102 is active. This is possible because the seismic signals 130a, 130b generated by the source 120 and the cleaning device's excitation are not located on the same frequency band and/or amplitude range. Thereby, it is possible to proceed to the comparison of step 612 while running source 102 and acquiring seismic data.

As discussed above, other devices than the cleaning device, e.g., any acoustic signal source, even moving faster than the cleaning device, may be used as long positioning means are present to provide the relative position of the excitation device along the cable. Such an acoustic source may include a GPS positioning device, or the acoustic source is a pulled device so that its position is directly dependent on the pulling cord (e.g., reel turns). The above embodiments may also be applied to optical fibers and sensing means located thereon, for e.g., other monitoring, like pipeline monitoring, where the device is moved by active means, and not water current. Such an example may be an optical fiber located in well and used for determining various parameters of the well or for determining the oil distribution around the well. In yet another application, it is possible to apply the above embodiments to determining a tension in a cable when the cable has plural sensors distributed along it, for example, cables associated with a building, bridge, etc. The above embodiments may even be applied to non-cable structures, like beams, rails, etc., that are configured with plural sensors and the external device can move along the structure.

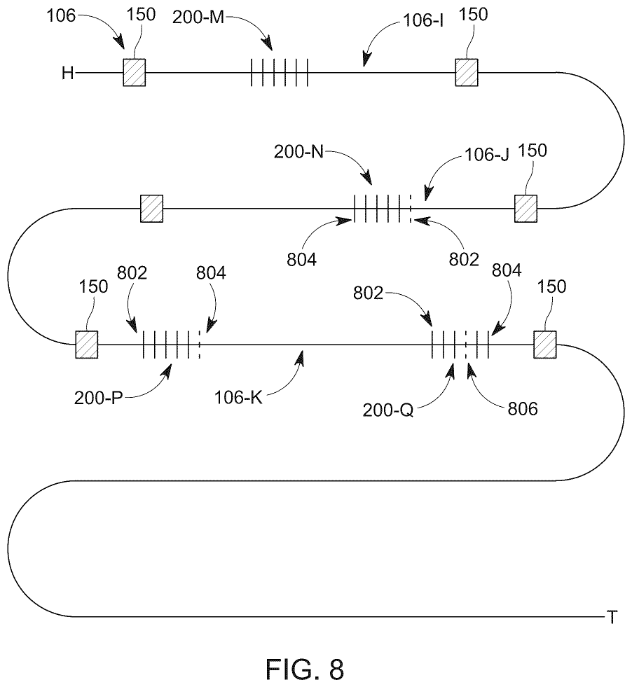

In a different embodiment, the location of the malfunctioning sensor is determined without knowing the position or speed of the cleaning device. As illustrated in FIG. 8, a streamer 106 is shown folded. Three sections 106-I, 106J, and 106-K of the streamer are considered for simplicity, where I, J, and K are integers different from each other. A receiver point 200-M is considered for the first section 106-I, a receiver point 200-N is considered for the second section 106-J, and two receiver points 200-P and 200-Q are considered for the third section 106-K. Any number of sections and receiver points may be considered for this embodiment. It is assumed that after the cleaning device or devices (if there is a cleaning device per streamer section) have passed their corresponding sections, at least one receiver point (e.g., 200-M) of at least one section (e.g., 106-I) has all its sensors (six sensors in this example) working. The receiver point 200-M may then be used as a reference point for determining sensors in the streamer that are not working.

In one embodiment, assume that the first sensor 802 of the receiver point 200-N is faulty (note that FIG. 8 indicates the head H and tail T of the streamer 106 and the sensors in a group are labeled as one to six (if only six sensors per group are present) starting from the head toward the tail of the streamer. For this scenario, after the cleaning device has passed section 106-J, the receiver point 200-N is found to have only five readings (on its corresponding trace) instead of the expected six. Because the distance of each sensor in receiver point 200-N relative to receiver point 200-M (the reference point) is known, the operator of the streamer is able to determine that the first sensor of receiver point 200-N is malfunctioning because for that position there is no reading on the corresponding trace. Note that the only other possibility (when five signals are present with no gap in between) is that the last sensor 804 of the receiver point 200-N is malfunctioning but this scenario is excluded here because the distance between the reference receiver point and the sensor not having a signature in the measured trace fits the first sensor 802 and not the last sensor 804.

In a different scenario, assume that the last sensor 804 of the receiver point 200-P in section 106-K is not working. After the data from all the sensors has been collected as the cleaning devices have passed each section of the streamer, the operator of the streamer notes that there are only five signatures for the receiver point 200-P, but it is not clear whether the first or the last sensor has failed. However, because the operator knows the exact position of each individual sensor in the receiver point 200-P relative to the reference receiver point 200-M, the operator can determine that the last sensor 804 has failed.

In yet another scenario, which is also illustrated in FIG. 8, a sensor 806 different from the first sensor 802 and the last sensor 804 of the receiver point 200-Q has failed. After the data from all the sensors has been collected as the cleaning devices have passed each section of the streamer, the operator of the streamer notes that there are only five signatures for the receiver point 200-Q, and because the signatures for the first and last sensors are present, the operator can identify which sensor within the receiver point 200-Q has failed as the operator knows the distances between all the sensors in this receiver point.

The cleaning device in these embodiments acts as a source of parasitic noise for those collecting seismic data for mapping the subsurface. However, this parasitic noise generated by the cleaning device is used to test each individual sensor. Those skilled in the art would understand that the cleaning device may be replaced by any other external device that generates a localized noise.

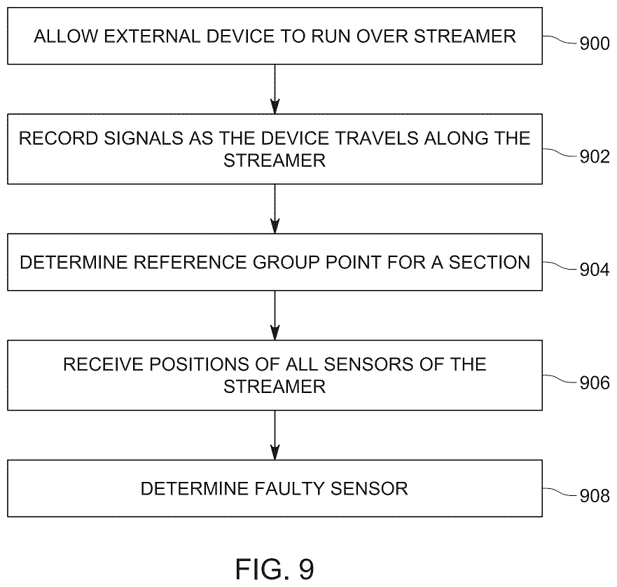

According to an embodiment illustrated in FIG. 9, there is a method testing each individual sensor of a streamer while the streamer is towed in water and collecting or not seismic data. The method includes a step 900 of running a noise generating device over a section of the streamer, a step 902 of using the sensors of the streamer for recording signals associated with noise generated by the external device, as it moves along the streamer, a step 904 of determining a reference receiver point for the section, a step 906 of receiving the positions of the sensors along the streamer, and a step 908 of determining the faulty sensor based on the recorded signals and the position of the reference group point. The external device is selected to generate a noise so that only one individual sensor of a receiver point detects the noise.

In one application, it is desired to use the above discussed methods and procedures for tracking a moving underwater mechanical device (e.g., streamer cleaning device) along the streamer through a conventional acoustic transducer system (i.e., the sensors of the streamer). Current technologies use complex and expensive equipment for this purpose, and they also need a battery and dedicated electronics. However, the traces 402 to 406 shown in FIG. 4 can be used to detect the location of the device as a signature of each individual sensor is activated only when the device passes on top of the individual sensor. Although plural sensors in a receiver point are wired together to generate a single output (i.e., a single trace), because of the localized sound generated by the device, each measured signal is indicative of an individual sensor. Because the position of all sensors along the streamer is known, the position of the device is determined when the corresponding individual sensor detects the presence of the device. This process may happen in real time as the global controller 101 on vessel 102 receives the measured signals from the group points in real time.

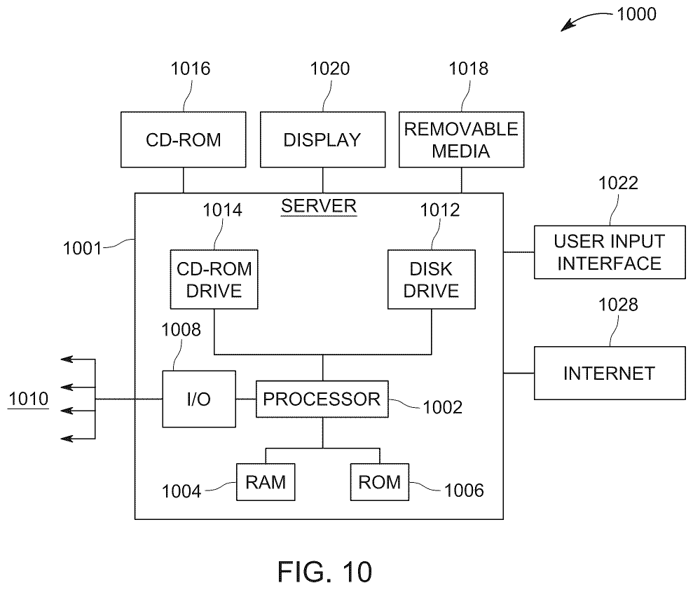

The above-discussed procedures and methods may be implemented in a computing device as illustrated in FIG. 10. Hardware, firmware, software or a combination thereof may be used to perform the various steps and operations described herein. The computing device 1000 is suitable for performing the activities described in the above embodiments and may include a server 1001. Such a server 1001 may include a central processor (CPU) 1002 coupled to a random access memory (RAM) 1004 and to a read-only memory (ROM) 1006. ROM 1006 may also be other types of storage media to store programs, such as programmable ROM (PROM), erasable PROM (EPROM), etc. Processor 1002 may communicate with other internal and external components through input/output (I/O) circuitry 1008 and bussing 1010 to provide control signals and the like. Processor 1002 carries out a variety of functions as are known in the art, as dictated by software and/or firmware instructions.

Server 1001 may also include one or more data storage devices, including hard drives 1012, CD-ROM drives 1014 and other hardware capable of reading and/or storing information, such as DVD, etc. In one embodiment, software for carrying out the above-discussed steps may be stored and distributed on a CD-ROM or DVD 1016, a USB storage device 1018 or other form of media capable of portably storing information. These storage media may be inserted into, and read by, devices such as CD-ROM drive 1014, disk drive 1012, etc. Server 1001 may be coupled to a display 1020, which may be any type of known display or presentation screen, such as LCD, plasma display, cathode ray tube (CRT), etc. A user input interface 1022 is provided, including one or more user interface mechanisms such as a mouse, keyboard, microphone, touchpad, touch screen, voice-recognition system, etc.

Server 1001 may be coupled to other devices, such as global controller of the vessel. The server may be part of a larger network configuration as in a global area network (GAN) such as the Internet 1028, which allows ultimate connection to various landline and/or mobile computing devices.

As described above, the apparatus 1000 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1002 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, processor 1002 may be configured to execute instructions stored in the memory device 1004 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The disclosed embodiments provide a method for determining the health of individual sensors wired in corresponding group points, which are distributed over plural portions of a structure, with the help of an external device that moves along the structure and generates a local noise. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for determining a health of an individual sensor, within a plurality of individual sensors that are wired together to form a receiver point, which produces a single trace, and the plurality of individual sensors are distributed along and within a cable, the method comprising:
receiving positions of the plurality of individual sensors along the cable;
recording the trace associated with measured plural signals from the plurality of individual sensors, as an external device moves along the cable, past the individual sensor; and
determining a health status of the individual sensor of the plurality of individual sensors by identifying a signature S_{I} of the individual sensor in the recorded trace,
wherein the external device emits a noise when moving along the cable, and the noise is detectable only by the individual sensor of the receiver point when the external device is located over the individual sensor.

2. The method of claim 1, wherein a length of the external device directly interacting with the cable and generating the noise is shorter than a distance between two adjacent individual sensors of the plurality of individual sensors.

3. The method of claim 1, wherein the trace includes signatures of all the plurality of individual sensors making up the receiver point, but the signatures are spaced in time as only a single sensor of the receiver point records the noise made by the external device, at any given instant.

4. The method of claim 1, further comprising:
towing the cable in water so that the external device moves along the cable.

5. The method of claim 1, wherein the step of recording comprises recording a root mean square of an energy of the plural measured signals.

6. The method of claim 5, further comprising:
calculating a speed of the external device based on the measured plural signals and the positions of the plurality of individual sensors along the cable; and
calculating a location of the external device along the cable, based on the speed of the external device.

7. The method of claim 6, further comprising:
comparing, for a given instant of time, an energy of the trace to an energy of a background noise when the external device is located at a location of the individual sensor for determining the health status of the individual sensor.

8. The method of claim 1, further comprising:
determining a working frequency range of the individual sensor based on the signature S_{I}.

9. The method of claim 1, wherein the external device is a cleaning device and the cable is a marine streamer.

10. The method of claim 1, wherein the plural sensors are hydrophones.

11. The method of claim 1, further comprising:
establishing a reference receiver point along the cable; and
mapping the signature S_{I} to the specific individual sensor of the receiver point based exclusively on the reference receiver point location and the received positions of the plural sensors along the cable.

12. A system for determining a health of an individual sensor distributed along and within a cable, the system comprising:
an interface configured to receive positions of plural sensors on the cable, the plural sensors being wired together to form a receiver point that produces a single trace; and
a processor connected to the interface and configured to,
receive the trace associated with measured plural signals from the plural sensors, as an external device moves past each sensor of the plural sensors; and
determine a health status of an individual sensor of the plural sensors by identifying a signature S_{I} of the individual sensor in the recorded trace,
wherein the external device emits a noise that is detectable only by the individual sensor of the receiver point when the external device is located over the individual sensor.

13. The system of claim 12, wherein the trace includes signatures of all the plural sensors making up the receiver point, but the signatures are spaced in time as only a single sensor of the receiver point records the noise made by the external device, at any given instant.

14. The system of claim 12, wherein the processor is further configured to:
receive a starting time of a movement of the external device along the cable;
calculate a speed of the external device based on the measured plural signals and the positions of the plural sensors along the streamer; and
calculate a location of the external device along the streamer, based on the speed of the external device.

15. The system of claim 14, wherein the processor is further configured to:
compare, for a given instant of time, an energy of the trace to an energy of a background noise when the external device is located at a location of the individual sensor for determining the health status of the individual sensor.

16. The system of claim 12, wherein the processor is further configured to:
determine a working frequency range of the individual sensor based on the signature S_{I}.

17. The system of claim 12, wherein the processor receives a root mean square of an energy of the plural measured signals.

18. The system of claim 12, wherein the external device is a cleaning device and the cable is a streamer.

19. The system of claim 12, wherein the plural sensors are hydrophones and/or accelerometers.

20. The system of claim 12, wherein the processor is located on board of a vessel that tows the cable.
